(19) United States
(12) Patent Application Publication
(10) Pub. No.: US 2023/0375320 A1
(43) Pub. Date: Nov. 23, 2023

(54) Linear Displacement Transducer

(71) Applicant: Schenck Process Australia Pty Limited, North Ryde NSW (AU)

(72) Inventors: Mariusz Milewicz, North Ryde NSW (AU); Jack Woodward, North Ryde NSW (AU)

(21) Appl. No.: 18/246,571

(22) PCT Filed: Sep. 20, 2021
(86) PCT No.: PCT/AU2021/051091

§ 371 Date: Mar. 24, 2023

(30) Foreign Application Priority Data
Sep. 25, 2020 (AU) 2020903452

(51) Int. Cl. G01B 3/20; G01B 7/14

(52) U.S. Cl. CPC G01B 3/20; G01B 7/14

(57) ABSTRACT

The invention relates to a linear displacement transducer (LDT) (1). The LDT (1) includes a first end (2) and a second end (3) with attachment means for attaching the ends to two points. The LDT includes a linear motion guide (6) between the ends which includes a first part (7) which is guided to move linearly relative to a second part (8) and measurement means for measuring linear displacement between the first and second parts of the linear motion guide. The ends are attached to the parts of the linear motion guide (6) through intermediate flexible members (16 and 17) which have relatively lower bending stiffness than the linear motion guide such that lateral relative movement between the first (2) and second (3) ends induces greater flexure in the intermediate members (16 and 17) than in the linear motion guide (6).

### FIELD OF THE INVENTION

The invention relates to a linear displacement transducer and more specifically, but not exclusively, to linear displacement transducer for use with a vibrating machine.

### BACKGROUND TO THE INVENTION

Linear displacement transducers (LDTs) are known in the art. LDTs are used to measure displacement between two points by converting the displacement to an electrical signal. To convert the movement to an electrical signal, mechanical, magnetic, or optical elements are used to derive the measurement.

One application of LDTs is to measure the displacement between a vibrating or oscillating machine and its base. In this application, the LDT is installed with one end fixed to the moving or oscillating part and the other end affixed to either a static or dynamic structure. The relative movement measured between these points may be used to derive various related measurements of the machine (e.g. velocity and acceleration of the moving part).

A problem encountered when using LDTs for such purposes, especially where used in high acceleration applications, is that movement between the points which deviates from a purely linear path may damage parts of the LDT. Further, traditional LDT housing designs are based on externally applied loads and do not consider the high inertia loads imparted on the housing in high acceleration, high cycle conditions. This causes parts in conventional LDT housings which are subjected to the high acceleration forces to rapidly fatigue and may cause parts to become detached from the measurement portion in use.

### OBJECT OF THE INVENTION

It is accordingly an object of the invention to provide a linear displacement transducer which alleviates some of the problems associated with the prior art or provides a useful alternative to the prior art. In preferred aspects, the invention addresses fatigue issues for applications in vibrating equipment by providing a more robust housing, and providing lateral flexibility in the connecting elements to provide accurate linear measurements whilst accommodating damaging transverse deflections.

### SUMMARY OF THE INVENTION

In accordance with the invention there is provided a linear displacement transducer including: a first end with attachment means for attaching the first end to a first point; a second end with attachment means for attaching the second end to a second point; a linear motion guide between the ends which includes a first part which is guided to move linearly relative to a second part; measurement means for measuring linear displacement between the first and second parts of the linear motion guide and providing the measurement as an electrical signal; the first end is attached to the first part of the linear motion guide through a first intermediate flexible member and the second end is attached to the second part of the linear motion guide through a second intermediate flexible member; the intermediate flexible members having relatively lower bending stiffness than the linear motion guide such that lateral relative movement between the first end and second end induces greater flexure in the intermediate members than in the linear motion guide and linear relative movement between the first end and the second end is transferred to the linear motion guide and is measurable by the measurement means as an estimate of the relative displacement between the first and second points.

The first end may be fixed and the second end may be movable.

The first and second parts of the linear motion guide may be cylindrical and the parts are movable relative to each other linearly about a shared central axis of the cylindrical parts.

The first part of the linear motion guide may be a barrel and the second part of the linear motion guide may be a plunger.

The plunger may include a guiding sleeve with an outer diameter corresponding to the inner diameter of the barrel.

The barrel may include a guiding sleeve with an inner diameter corresponding to the outer diameter of the plunger such that, when the sleeves engage the plunger and barrel, the plunger and barrel are guided to move linearly relative to each other about a shared central axis of the guiding sleeves.

The sleeves may be made of polytetrafluoroethylene (PTFE), brass, bronze, hardened steel, ceramics, thermoplastic elastomer (TPE) or thermoplastic polyurethane (TPU).

The plunger may include a plurality of rollers which roll along an inner surface of the barrel to guide the movement of the plunger and the barrel relative to each other about a central axis of the guiding sleeves.

At least part of the measurement means may be located inside one of the intermediate flexible members.

The measurement means may include a pulse generator and sensor unit connected to an elongated magnetostrictive waveguide within the barrel and an annular magnet which is attached to the plunger and moves about the waveguide, wherein the measurement means determines a position of the magnet along the elongated waveguide.

The pulse generator generates and transmits a pulse through the waveguide, detects a reflection of the pulse, and uses the time difference to measure the position of the magnet.

The measurement means may include an ultrasonic transducer in the barrel which generates an ultrasonic pulse and measures echo time of a reflection of the pulse off at least part of the plunger to determine the distance between the part of the plunger and the transducer.

The measurement means may use laser distance measurement apparatus to measure distance between the barrel and the plunger.

The laser distance measurement apparatus uses the time of flight principle to determine distance between the barrel and the plunger.

The laser distance measurement apparatus uses triangulation to determine distance between the barrel and the plunger.

At least one of the ends may have attachment means which include a clevis.

The intermediate flexible members are made of hydraulic hose.

The linear displacement transducer may include an extendible cover over the linear motion guide.

### BRIEF DESCRIPTION OF THE DRAWINGS

An embodiment of the invention is described below, by way of a non-limiting example only, and with reference to the accompanying drawings in which:

FIG. 1 is a schematic perspective view of a linear displacement transducer;

FIG. 2 is a schematic plan view of a linear displacement transducer;

FIG. 3 is sectional view A-A as indicated in FIG. 2;

FIG. 4 is a schematic exploded view of a second embodiment of a linear displacement transducer; and

FIG. 5 is detail view A as indicated in FIG. 4.

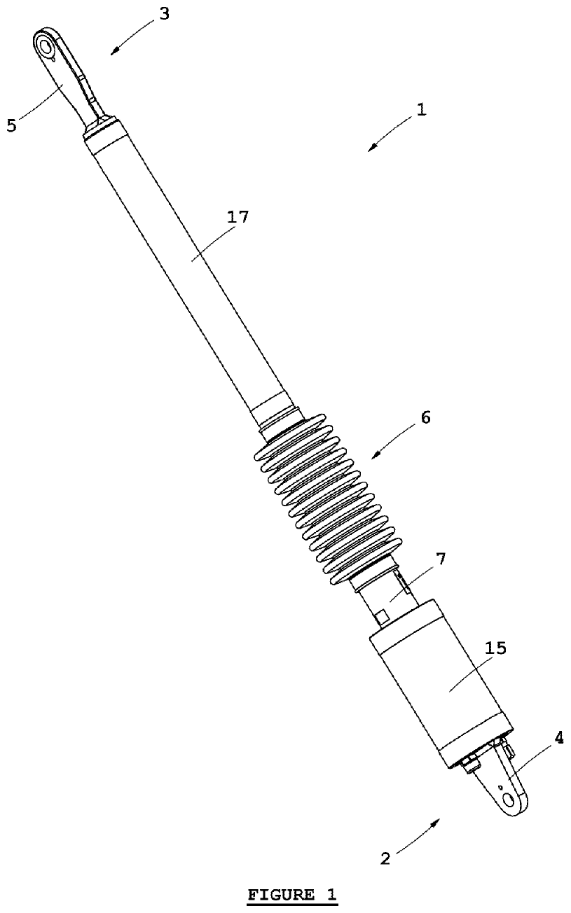

### DETAILED DESCRIPTION OF THE DRAWINGS

With reference to the drawings, in which like features are indicated by like numerals, a linear displacement transducer (LDT) is generally indicated by reference numeral 1.

The LDT has a first end 2 and a second end 3. The first end 2 includes attachment means in the form of a clevis 4 and the second end 3 also includes attachment means in the form of a clevis 5. The attachment means allows the LDT 1 to be installed between two points.

Between the first end 2 and the second end 3 is a linear motion guide (generally indicated by reference numeral 6). The purpose of the linear motion guide 6 is to guide and force linear motion between its two parts. A first part 7 of the linear motion guide 6, which is operatively located proximate to the first end 2, guides linear movement relative to its second part 8. In the embodiment described and depicted herein, the first part 7 and second part 8 are in the form of a barrel 7 and plunger 8 respectively.

The barrel 7 and plunger 8 are substantially cylindrical and are arranged concentrically to move relative to each other only linearly along the shared central axis of the cylinders. This is achieved by utilizing sliding sleeves (or bearings) located on both the plunger 8 and the barrel 7. The sliding sleeve 9, located at one end of the plunger 8, is annular and has an outer diameter which corresponds to the inner diameter of the barrel 7.

The sliding sleeve 9 is made of polytetrafluoroethylene (PTFE) which has a very low coefficient of friction to allow the plunger 8 to move linearly and easily in the barrel 7. Similarly, the end of the barrel 7 has a removable cap 10 with an inner sliding sleeve 11 therein. The sliding sleeve 11 has an inner diameter which corresponds to the outer diameter of the plunger 8 and is made of PTFE, with a low coefficient of friction, to allow the plunger to move linearly and easily through the sliding sleeve 11. In the arrangement as shown in the figures, the sliding sleeve 9, the sliding sleeve 11, the cylindrical body of the plunger 8, and the cylindrical body of the barrel 7 all being substantially annular and cylindrical all share a common central axis, substantially in the direction of the guided linear movement.

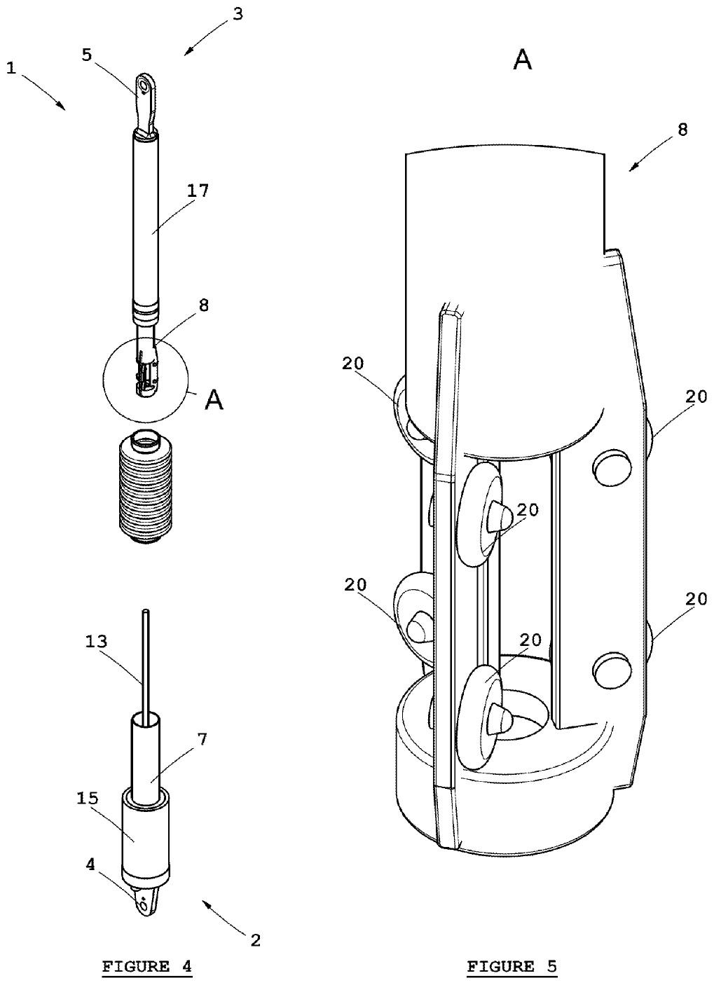

FIGS. 4 and 5 show a second embodiment of the LDT 1. This second embodiment is similar to the first embodiment but with a different arrangement of the barrel 7 and plunger 8. In this embodiment the barrel 7 and plunger 8 do not make use of sliding sleeves (9 and 11 in the first embodiment) to guide the movement between the barrel 7 and plunger 8. Instead, the second embodiment makes use of rollers 20, arranged in pairs at 120° intervals along the plunger, which roll and move along an axis parallel to the shared central axis of the barrel 7 and plunger 8 to guide the plunger 8. The rollers 20 are arranged such that the circumscribed diameter of the outermost portions of the rollers 20 correspond to the inner diameter of the barrel 7. This allows plunger 8 to move linearly and easily through the barrel 7 and guide linear movement.

The LDT 1 includes measurement means for measuring relative displacement between the plunger 8 and the barrel 7. The measurement provides the measurement as an electrical signal. This may be achieved in a number of ways. In the embodiment described herein, the measurement means is magnetic and uses an annular or toroidal magnet 12, which is located on the plunger 8, to measure the displacement relative to a stationary elongated waveguide 13. The elongated waveguide 13 is connected to a control unit 14 which includes at least a current pulse generator and a torsional sensor unit. The control unit 14 sends current pulses through the waveguide 13 which interact with the magnetic field of the magnet 12 and produces a mechanical torsional strain which may be measured by the torsional sensor unit. The time difference between the transmitted pulse and a recorded torsional strain may be used to derive the distance between the magnet and the pulse generator. Similarly, the measurement means may be in the form of an ultrasonic transducer or a laser distance measurement device to measure the distance and displacement between the plunger 8 and the barrel 7.

The linear motion guide 6 is located centrally to the LDT 1 (concentric to the central axis) to measure linear movement thereof and may, generally, use any suitable means to measure the displacement between the plunger 8 and barrel 7. The first end 2 end the second end 3 are connected to each other through the central linear motion guide 6 through intermediate flexible members. The first flexible intermediate member 15, connects the first end 2 to the barrel 7 through end plate 16. The second end 3 is connected to the plunger 8 through flexible intermediate member 17. In the example described herein, the flexible members are in the form of hydraulic hoses which are connected to the other parts by hose clamps, or any other suitable connection.

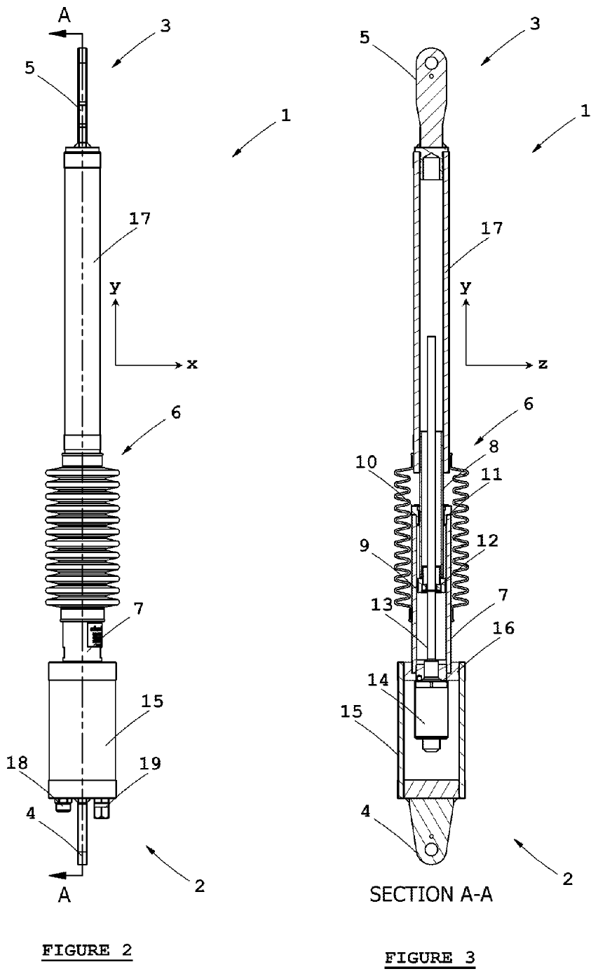

In the prior art, where a linear displacement transducer is used to measure displacement of a vibrating machine, especially where such machine is subjected to high acceleration and lateral movement, the lateral movement which is not axially linear may exert forces on the fragile measurement part and cause the measurement part to fail. The invention adds intermediate flexible members which have greater relative flexibility in bending than in linear tension and compression. The intermediate flexible members also have relatively lower bending stiffness than the linear motion guide. A bending moment applied to the LDT 1 as a result of lateral (x-z plane) relative movement between the first end 2 and second end 3 induces greater flexure in the intermediate members than in the linear motion guide 6. Linear relative movement (in the y-direction along the longitudinal axis of the LDT 1) will induce compressive and tensile strain in the flexible members and linear motion guide 6. As the linear motion guide 6 has very low mechanical friction or resistance for axial movement, the induced strain is negligible. This allows linear motion (in the y-direction as shown in FIGS. 2 and 3 along the longitudinal axis of the LDT 1) between the ends to be effectively transferred and measured by the measurement means within the linear motion guide 6 (which provides an estimate of the displacement between the points) whilst lateral motion (in the x-z plane) between the ends, which is potentially damaging, is absorbed as flexure of the intermediate flexible members.

At least part of the measurement means may be located inside one of the intermediate flexible members. In the example described herein, the control unit 14 which contains all electronics and circuitry to accurately determine the position of the magnet 12, is located within the intermediate flexible member 15. This prevents lateral movement from damaging the control unit 14. In addition, the LDT 1 includes a pressure equalizer valve 18 to ensure an undisturbed movement of the plunger 8. The LDT 1 also includes an electronic connector 19.

It is envisaged that the invention will provide an LDT which provides an accurate estimation of linear displacement between two points whilst not being affected by lateral motion which is present in many applications of LDTs. The LDT described herein is robust and, in certain aspects, may be employed to measure displacement in significantly higher acceleration environments than the prior art through elimination of the need for spherical bearings and other fixings with poor fatigue performance.

The invention is not limited to the precise details as described herein. For example, instead of using a clevis as attachment means, shackles, brackets or pinned connections may be employed. Instead of using hydraulic hose as intermediate flexible members, a solid flexible rod, or any other similarly bendable member may be used to achieve the desired purpose. Further, instead of the sleeves being made of polytetrafluoroethylene (PTFE), the sleeves may be made of brass, bronze, hardened steel, ceramics, thermoplastic elastomer (TPE) or thermoplastic polyurethane (TPU).

1. A linear displacement transducer including: a first end with attachment means for attaching the first end to a first point; a second end with attachment means for attaching the second end to a second point; a linear motion guide between the ends which includes a first part which is guided to move linearly relative to a second part; measurement means for measuring linear displacement between the first and second parts of the linear motion guide and providing the measurement as an electrical signal; the first end is attached to the first part of the linear motion guide through a first intermediate flexible member and the second end is attached to the second part of the linear motion guide through a second intermediate flexible member; and the intermediate flexible members having relatively lower bending stiffness than the linear motion guide such that lateral relative movement between the first end and second end induces greater flexure in the intermediate members than in the linear motion guide and linear relative movement between the first end and the second end is transferred to the linear motion guide and is measurable by the measurement means as an estimate of the relative displacement between the first and second points.

2. The linear displacement transducer of claim 1 wherein the first end is fixed and the second end is movable.

3. The linear displacement transducer of claim 1 wherein first and second parts of the linear motion guide are cylindrical and the parts are movable relative to each other linearly about a shared central axis of the cylindrical parts.

4. The linear displacement transducer of claim 3 wherein the first part of the linear motion guide is a barrel and the second part of the linear motion guide is a plunger.

5. The linear displacement transducer of claim 4 wherein the plunger includes a guiding sleeve with an outer diameter corresponding to the inner diameter of the barrel.

6. The linear displacement transducer of claim 5 wherein the barrel includes a guiding sleeve with an inner diameter corresponding to the outer diameter of the plunger such that, when the sleeves engage the plunger and barrel, the plunger and barrel are guided to move linearly relative to each other about a central axis of the guiding sleeves.

7. The linear displacement transducer of claim 6 wherein the sleeves are made of polytetrafluoroethylene (PTFE).

8. The linear displacement transducer of claim 4 wherein the plunger includes a plurality of rollers which roll along an inner surface of the barrel to guide the movement of the plunger and the barrel relative to each other about a central axis of the guiding sleeves.

9. The linear displacement transducer of claim 4 wherein at least part of the measurement means is located inside one of the intermediate flexible members.

10. The linear displacement transducer of claim 4 wherein the measurement means includes a pulse generator and sensor unit connected to an elongated magnetostrictive waveguide within the barrel and an annular magnet which is attached to the plunger and moves about the waveguide, wherein the measurement means determines a position of the magnet along the elongated waveguide.

11. The linear displacement transducer of claim 10 wherein the pulse generator generates and transmits a pulse through the waveguide, detects a reflection of the pulse, and uses the time difference to measure the position of the magnet.

12. The linear displacement transducer of claim 4 wherein the measurement means includes an ultrasonic transducer in the barrel which generates an ultrasonic pulse and measures echo time of a reflection of the pulse off at least part of the plunger to determine the distance between the part of the plunger and the transducer.

13. The linear displacement transducer of claim 4 wherein the measurement means uses laser distance measurement apparatus to measure distance between the barrel and the plunger.

14. The linear displacement transducer of claim 13 wherein the laser distance measurement apparatus uses the time of flight principle to determine distance between the barrel and the plunger.

15. The linear displacement transducer of claim 13 where the laser distance measurement apparatus uses triangulation to determine distance between the barrel and the plunger.

16. The linear displacement transducer of claim 1 wherein at least one of the ends has attachment means which include a clevis.

17. The linear displacement transducer of claim 1 wherein the intermediate flexible members are made of hydraulic hose.

18. The linear displacement transducer of claim 1 wherein the linear displacement transducer includes an extendible cover over the linear motion guide.
